(19) United States
(12) Patent Application Publication
(10) Pub. No.: US 2024/0231352 A1
(43) Pub. Date: Jul. 11, 2024

(54) MANAGEMENT APPARATUS, NON-TRANSITORY COMPUTER READABLE MEDIUM, AND MANAGEMENT SYSTEM

(71) Applicant: FUJIFILM BUSINESS INNOVATION CORP., Tokyo (JP)

(72) Inventor: Yuya HIRAYAMA, Kanagawa (JP)

(73) Assignee: FUJIFILM BUSINESS INNOVATION CORP., Tokyo (JP)

(21) Appl. No.: 18/353,461

(22) Filed: Jul. 17, 2023

(30) Foreign Application Priority Data
Jan. 5, 2023 (JP) 2023-000738

(51) Int. Cl. G05B 23/02; G06Q 10/087

(52) U.S. Cl. CPC G05B 23/0283; G06Q 10/087

(57) ABSTRACT

A management apparatus includes: a processor configured to: detect an identified component quantity of stock of which is lower than or equal to a threshold from among components included in each of processing apparatuses that are connected by using a communication network; transmit, to a processing apparatus of the processing apparatuses that uses the identified component, an anomaly diagnosis request for diagnosing whether the identified component has a failure; receive a result of diagnosing the identified component from the processing apparatus to which the anomaly diagnosis request is transmitted; and output an instruction to assign a stocked identified component to a processing apparatus of the processing apparatuses that is determined as including the identified component having the failure on a basis of the result of diagnosing the identified component.

### CROSS-REFERENCE TO RELATED APPLICATIONS

This application is based on and claims priority under 35 USC 119 from Japanese Patent Application No. 2023-000738 filed Jan. 5, 2023.

### BACKGROUND

### (i) Technical Field

The present disclosure relates to a management apparatus, a non-transitory computer readable medium, and a management system.

### (ii) Related Art

Japanese Unexamined Patent Application Publication No. 2022-107423 discloses a maintenance support system that outputs, to a predetermined image output device, an alarm for reporting a request for maintenance of a machine to be managed. The maintenance support system includes an operating data database, a required article database, a failure case database, a component stock database, and a processing apparatus. In the operating data database, pieces of operating data regarding the machine to be managed are accumulated. In the required article database, required articles to be used for maintenance of the machine to be managed and the quantity of the required articles are specified for each of failure items of the machine. In the failure case database, pieces of past data in a period from an anomaly determination until actual failure occurrence are accumulated on the basis of an evaluation value computed to evaluate the soundness of the machine to be managed. The processing apparatus generates the alarm and outputs the alarm to the image output device. In the component stock database, pieces of data regarding the quantity of stock are accumulated for each required article. the processing apparatus computes the evaluation value on the basis of the operating data database and determines whether the machine to be managed is in a normal state or in an anormal state on the basis of the evaluation value. If the processing apparatus determines that the machine to be managed is in the anormal state, the processing apparatus estimates, for a failure item failure occurrence regarding which is predicted, a required article to be used for the maintenance and the quantity of the required article on the basis of the required article database, estimates a period left until the failure occurrence of the failure item on the basis of the evaluation value based on which the anomaly is determined and the failure case database, and estimates a procurement period required to procure the required article from the component stock database. If a value obtained by subtracting the procurement period from the period left is lower than or equal to a set value set in advance, the processing apparatus outputs, to the image output device, the alarm that reports the maintenance request including information regarding the predicted failure item and the required article.

### SUMMARY

For example, difficulty in obtaining a component of an apparatus and a material of the component causes a longer period for delivery of an ordered component than a usual period for delivery of the component on occasions.

Accordingly, if a component has a failure, and if the stock status of the component is not known, the apparatus is not usable on occasions until a component for replacement is available.

Aspects of non-limiting embodiments of the present disclosure relate to a management apparatus, a non-transitory computer readable medium, and a management system that are enabled to manage a component to reduce the frequency of occurrence of an apparatus unavailable period caused by a component stockout.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a management apparatus including: a processor configured to: detect an identified component quantity of stock of which is lower than or equal to a threshold from among components included in each of processing apparatuses that are connected by using a communication network; transmit, to a processing apparatus of the processing apparatuses that uses the identified component, an anomaly diagnosis request for diagnosing whether the identified component has a failure; receive a result of diagnosing the identified component from the processing apparatus to which the anomaly diagnosis request is transmitted; and output an instruction to assign a stocked identified component to a processing apparatus of the processing apparatuses that is determined as including the identified component having the failure on a basis of the result of diagnosing the identified component.

### BRIEF DESCRIPTION OF THE DRAWINGS

An exemplary embodiment of the present disclosure will be described in detail based on the following figures, wherein:

FIG. 1 is a view illustrating an example configuration of a management system;

FIG. 2 is a view illustrating an example functional configuration of a management server;

FIG. 3 is a view illustrating an example of a stock table;

FIG. 4 is a view illustrating an example of a used component table;

FIG. 5 is a view illustrating an example of an apparatus management table;

FIG. 6 is a view illustrating an example of reference sound data;

FIG. 7 is a view illustrating an example of a maintenance management table;

FIG. 8 is a view illustrating an example of an operating information table;

FIG. 9 is a view illustrating an example functional configuration of an image forming apparatus;

FIG. 10 is an example schematic view of an image forming unit;

FIG. 11 is a view illustrating example operation logs;

FIG. 12 is a view illustrating an example configuration of an electrical system of the image forming apparatus;

FIG. 13 is a view illustrating an example configuration of an electrical system of the management server;

FIG. 14 is a flowchart illustrating an example of a determination process;

FIG. 15 is a flowchart illustrating an example of an identification process; and

FIG. 16 is a flowchart illustrating an example of an identified component assignment process.

### DETAILED DESCRIPTION

Hereinafter, an exemplary embodiment disclosed will be described with reference to the drawings. The same components and the same processes are denoted by the same reference numerals throughout the drawings, and repeated explanation thereof is omitted.

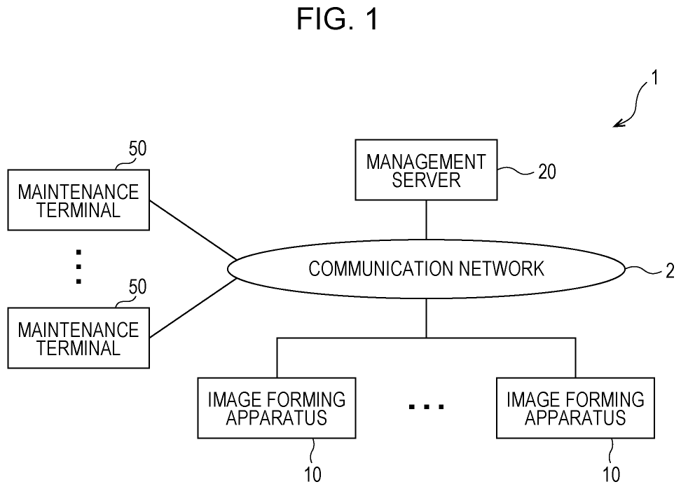

FIG. 1 is a view illustrating an example configuration of a management system 1 that manages image forming apparatuses 10. The management system 1 includes the image forming apparatuses 10, a management server 20 that manages the image forming apparatuses 10, and maintenance terminals 50. The image forming apparatuses 10, the management server 20, and the maintenance terminals 50 are connected to each other via a communication network 2 such as the Internet.

The image forming apparatus 10 is an example of a processing apparatus having at least one function related to image forming. The management system 1 includes the multiple image forming apparatuses 10. There is no limitation on the installation place of each image forming apparatus 10. For example, the image forming apparatuses 10 may be installed in the same building and may be installed in respective different places.

Examples of the functions of each image forming apparatus 10 include a printing function of printing an image represented by image data on a paper sheet P, a scanning function of optically reading an image on the document and then generating image data, and a copying function of copying an image on the document onto a different paper sheet P. For convenience of explanation, the image forming apparatus 10 has the printing function. In the printing function, in response to, for example, transportation of a paper sheet P on which an image is to be formed, image forming on the paper sheet P with toner or ink, fixing the image formed on the paper sheet P, relevant components operate, and relevant operating sounds are produced.

Any type of processing apparatus may be used in place of the image forming apparatus 10 as long as the processing apparatus produces sound in response to an operation of a function designated by a user. For example, in place of the image forming apparatus 10, any of various manufacturing apparatuses used for manufacturing a component or apparatuses for driving a side window of a vehicle may be connected to the communication network 2, and the management server 20 may manage the operating states of the apparatuses.

The management server 20 is an example of a management apparatus that acquires, from the image forming apparatus 10, information regarding the operating state of the image forming apparatus 10 and that executes a process appropriate for the operating state of the image forming apparatus 10. In the example as the management system 1 illustrated in FIG. 1, the one management server 20 manages the image forming apparatuses 10; however, multiple management servers 20 may manage the image forming apparatuses 10. In this case, for example, each image forming apparatus 10 to be managed by a corresponding one of the management servers 20 may be decided in advance.

Each maintenance terminal 50 is a terminal installed in a corresponding one of business offices that manage a corresponding one or more of the image forming apparatuses 10. In response to receiving a maintenance request to the image forming apparatus 10 from the management server 20, the maintenance terminal 50 outputs information regarding one of the image forming apparatuses 10 to be maintained and maintenance details to a maintenance person belonging to the business office. In answer to the maintenance request, the maintenance person visits the installation place of the image forming apparatus 10 to be maintained and performs the maintenance of the image forming apparatus 10 in accordance with the designated maintenance details.

The functions of the management server 20 and the image forming apparatus 10 will then be described in detail.

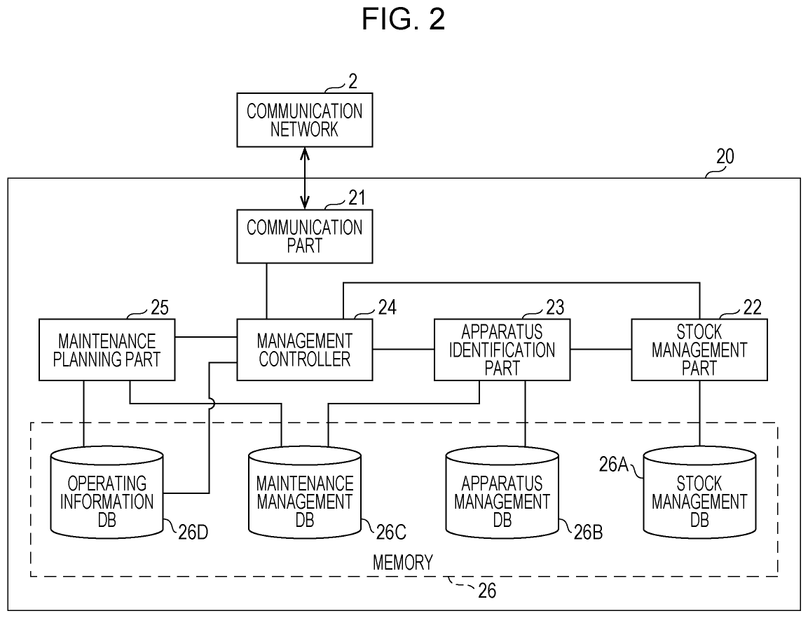

FIG. 2 is a view illustrating an example functional configuration of the management server 20. The management server 20 has the functions of a communication part 21, a stock management part 22, an apparatus identification part 23, a management controller 24, and a maintenance planning part 25 and includes a memory 26.

The communication part 21 interactively performs data communication with each image forming apparatus 10 and each maintenance terminal 50 via the communication network 2. Further, the communication part 21 interactively performs data communication with an apparatus (referred to as an external apparatus) that is not included in the management system 1 but is connected to the communication network 2.

The stock management part 22 manages the stock of the components used for the image forming apparatus 10 by using a stock table 51 stored in a stock management database (DB) 26A in the memory 26.

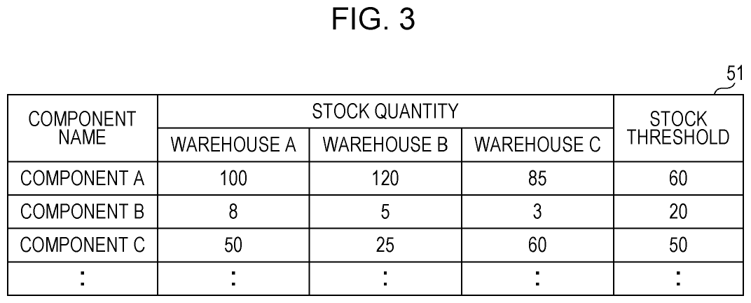

FIG. 3 is a view illustrating an example of the stock table 51. As illustrated in FIG. 3, the stock table 51 includes stock information regarding each component used in the image forming apparatus 10. The stock information regarding the component is composed of a component name, the quantity of stock, and a stock threshold.

In the stock information regarding the component, the component name represents the name of the component used in the image forming apparatus 10. The name used as the component name is only required to be a name enabling the component to be uniquely identified in the management system 1, and thus, for example, a component number is used.

In the stock information regarding the component, the quantity of stock represents the quantity of stock of the component stocked in advance for repairing in the case of the occurrence of an anomaly in the image forming apparatus 10. If components for repair are stored in multiple places, the quantity of stock of each component is recorded as in the stock table 51 in FIG. 3 for each storage place. The example as the stock table 51 in FIG. 3 illustrates components for repair are stored in three storage places of a warehouse A, a warehouse B, and a warehouse C in a distributed manner. The quantity of stock of each component is updated with the latest quantity of stock on the basis of, for example, reports from the respective warehouses.

A period for delivery from an order for the component for repair as described above to delivery thereof varies with the component. The quantity of stock required for preventing the occurrence of a period in which the image forming apparatus 10 is not usable due to the stockout of the component for repair thus varies with the component.

Accordingly, the stock threshold in the stock information regarding the component represents a minimum component stock quantity required for the maintenance of the image forming apparatus 10. The stock threshold is set in advance by a stock manager to prevent the component from being out of stock on the basis of a delivery period for the component representing the availability of the component and past repair statuses of the image forming apparatus 10. Specifically, the stock threshold of a component having a longer period for delivery or more likely to have a failure than other components is preferably set higher.

The stock management part 22 monitors whether there is a component total stock of which in a warehouse is lower than or equal to a stock threshold with reference to the stock table 51, for example, every predetermined period. If a component the quantity of stock of which is lower than or equal to the stock threshold is present, the stock management part 22 reports, to the apparatus identification part 23, the name of the component the quantity of stock of which is lower than or equal to the stock threshold. Hereinafter, the component the quantity of stock of which is lower than or equal to the stock threshold is referred to as an identified component.

Items included in the stock information regarding the component is not limited to items illustrated in FIG. 3. For example, the average period for delivery of a component, information regarding warehouse location, or the like may be included in the stock information regarding the component.

In response to receiving the report regarding the identified component from the stock management part 22, the apparatus identification part 23 in FIG. 2 identifies one or more image forming apparatuses 10 using the identified component from among the image forming apparatuses 10 included in the management system 1.

The apparatus identification part 23 thus identifies each image forming apparatus 10 using the identified component by using a used component table 52 and an apparatus management table 53 stored in an apparatus management DB 26B in the memory 26.

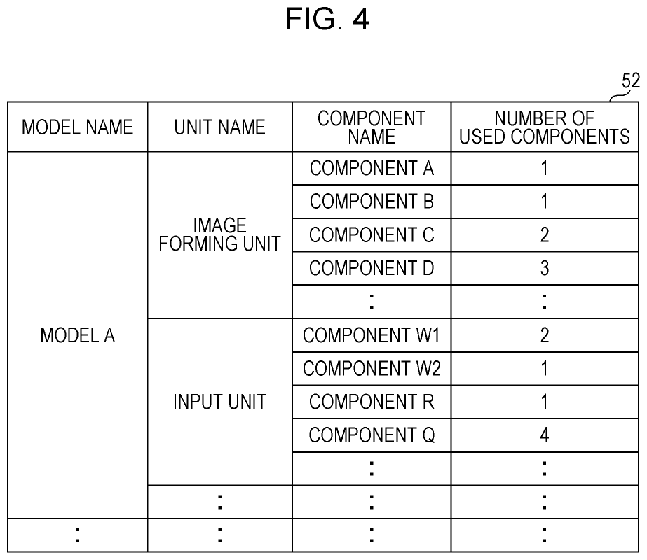

FIG. 4 is a view illustrating an example of the used component table 52. There are various models for the image forming apparatuses 10 on the basis of their usage, and used components vary with the model. Accordingly, as illustrated in FIG. 4, the used component table 52 includes used component information regarding each model for a corresponding one of the image forming apparatuses 10.

Each piece of used component information is composed of a model name, a unit name, a component name, and the number of used components.

In the used component information, the model name represents the name of the model of the image forming apparatus 10. The name used as the model name is only required to be a name enabling the model of the image forming apparatus 10 in the management system 1 to be uniquely identified, and thus, for example, the model number is used.

The functions of each image forming apparatus 10 are implemented by, for example, units 37. The image forming apparatus 10 of the disclosure has a printing function and thus includes an image forming unit 37D. The image forming apparatus 10 of the disclosure also includes an input unit 37B to receive an instruction from the user.

In the used component information, as described above, the unit name represents the name of a unit 37 included in the image forming apparatus 10 for each model.

In the used component information, the component name represents the name of a used component for each model and each unit 37.

In the used component information, the number of used components represents the number of used components for each model and each unit 37.

The apparatus identification part 23 refers to the used component table 52 and thereby identifies the model of the image forming apparatus 10 using the identified component and the unit 37 using the identified component in the image forming apparatus 10.

Items included in the used component information are not limited to items illustrated in FIG. 4. For example, the price of the component may be included in the used component information.

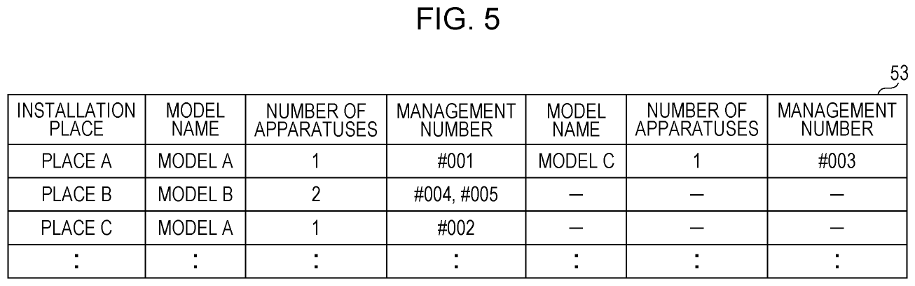

In contrast, FIG. 5 is a view illustrating an example of the apparatus management table 53. The apparatus management table 53 includes installation information regarding the image forming apparatus 10 installed in the corresponding place. The installation information regarding the image forming apparatus 10 is composed of an installation place, a model name, the number of apparatuses, and a management number.

In the installation information regarding the image forming apparatus 10, the installation place represents a place where the image forming apparatus 10 is installed. The installation place is only required to be information enabling the place where the image forming apparatus 10 is installed to be uniquely identified, and thus, for example, an address is used. However, the installation place may be expressed by using the longitude and the latitude.

In the installation information regarding the image forming apparatus 10, the model name represents the name of the model of the image forming apparatus 10 installed in the installation place.

In the installation information regarding the image forming apparatus 10, the number of apparatuses represents the number of image forming apparatuses 10 that correspond to the model represented by the model name and that that are installed in the installation place.

In the installation information regarding the image forming apparatus 10, the management number is a number for identifying the image forming apparatus 10 installed in the corresponding installation place. The management number is only required to be a number enabling the image forming apparatus 10 installed in the corresponding place to be uniquely identified, and thus, for example, a manufacturing number is used.

If the image forming apparatuses 10 of multiple models are installed in the same installation place, the model name, the number of apparatuses, and the management number are recorded for each model of the image forming apparatus 10 in the apparatus management table 53.

Items included in the installation information regarding the image forming apparatus 10 are not limited to items illustrated in FIG. 5. For example, the installation date for the image forming apparatus 10 or a person in charge of managing the image forming apparatus 10 in the installation place may be installed in the installation information regarding the image forming apparatus 10.

The apparatus identification part 23 refers to the apparatus management table 53 and thereby knows the management number, the installation place, and the number of apparatuses of the image forming apparatus 10 using the identified component. The apparatus identification part 23 then reports the management number, the unit 37, and the identified component of the image forming apparatus 10 using the identified component to the management controller 24.

The management controller 24 in FIG. 2 controls the communication part 21, the stock management part 22, the apparatus identification part 23, and the maintenance planning part 25 to implement functions required by the management server 20. For example, in response to receiving the report regarding the management number from the apparatus identification part 23, the management controller 24 transmits, to each image forming apparatus 10 represented by the corresponding management number, an anomaly diagnosis request for diagnosing whether the identified component has a failure.

Specifically, the management controller 24 adds the component name of the identified component, the unit name corresponding the use of the identified component, and the reference sound data regarding the unit 37 using the identified component to the anomaly diagnosis request. The management controller 24 then controls the communication part 21 and transmits the anomaly diagnosis request to the image forming apparatus 10 represented by the management number.

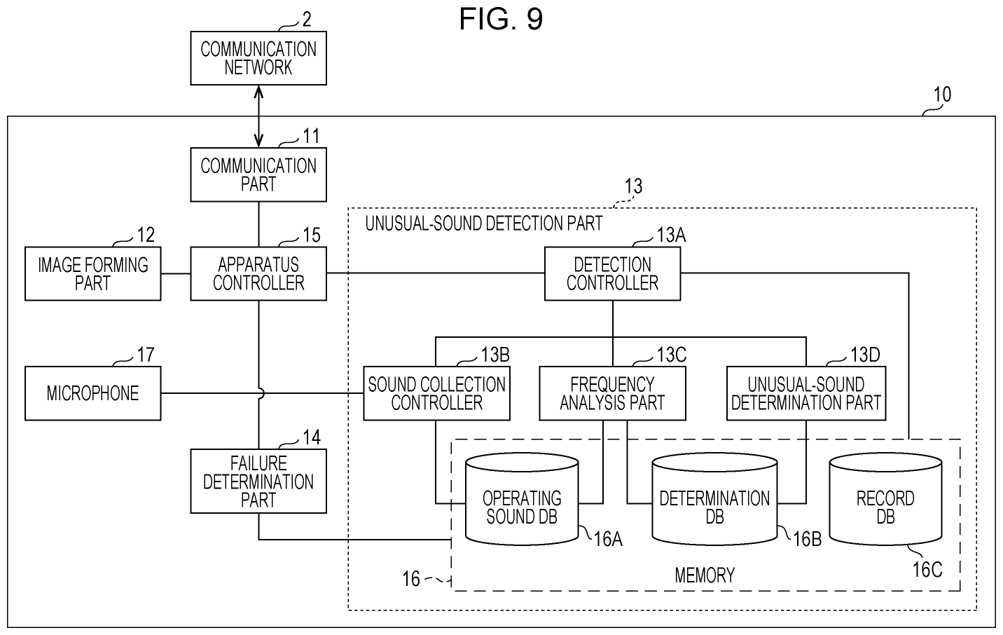

The reference sound data is sound data regarding the image forming apparatus 10 in operation. In the reference sound data, a raw sound acquired without occurrence of a failure on any component included in the image forming apparatus 10 is recorded. Specifically, the reference sound data is data regarding sound collected for each unit 37 of the corresponding image forming apparatus 10 corresponding to the model. For example, before the image forming apparatus 10 is shipped from the factory, the sound is collected with a microphone 17 (FIG. 9) included in the image forming apparatus 10 and stored in a maintenance management DB 26C.

The reference sound data is thus sound data representing operating sound for each unit 37 acquired with the image forming apparatus 10 being appropriately operating. As the reference sound data, data common to one model may be used. Sounds may also be collected for each image forming apparatus 10 because the image forming apparatuses 10 of the same model have different operating sounds on occasions.

The reference sound data does not have to be sound data and may be frequency analysis data acquired by performing frequency analysis on sound data.

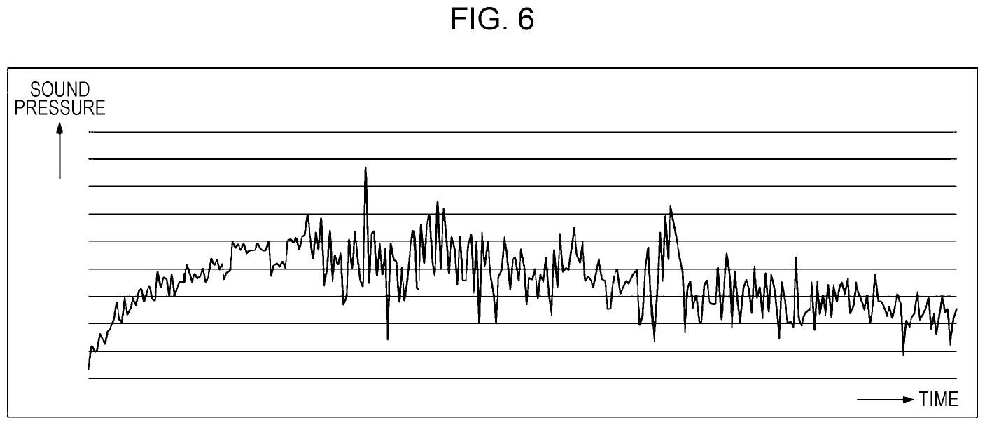

FIG. 6 is a view illustrating an example of the reference sound data. As illustrated in FIG. 6, the reference sound data is data representing the loudness of sound in time units, that is, chronological sound pressures and represents raw sound collected with the microphone 17 in a period in which the unit 37 including the identified component is operating.

The image forming apparatus 10 having received the anomaly diagnosis request from the management server 20 collects operating sound data regarding the unit 37 corresponding to the unit name added to the anomaly diagnosis request, with the microphone 17 included in the image forming apparatus 10. The image forming apparatus 10 compares the acquired operating sound data with the reference sound data added to the anomaly diagnosis request and thereby diagnoses whether the identified component included in the unit 37 and designated in the anomaly diagnosis request has a failure, that is, the state of the identified component. The image forming apparatus 10 transmits, to the management server 20, the result of diagnosing the identified component (hereinafter, also simply referred to as a diagnosis result) together with the management number of the image forming apparatus 10.

In response to receiving the diagnosis result from each image forming apparatus 10 to which the anomaly diagnosis request is transmitted, the communication part 21 reports the received diagnosis result to the maintenance planning part 25 via the management controller 24.

In response to receiving the diagnosis result from the management controller 24, the maintenance planning part 25 in FIG. 2 outputs, to the maintenance terminal 50, an instruction to assign a stocked identified component to the image forming apparatus 10 determined as including the identified component having a failure, on the basis of the diagnosis result.

The maintenance planning part 25 thus decides the image forming apparatuses 10 to be assigned the stocked identified component, by using a maintenance management table 54 stored in a maintenance management DB 26C in the memory 26.

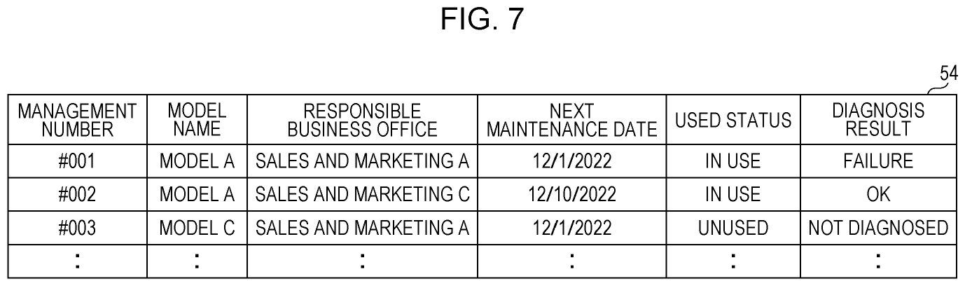

FIG. 7 is a view illustrating an example of the maintenance management table 54. As illustrated in FIG. 7, the maintenance management table 54 includes maintenance information for each image forming apparatus 10. Each of pieces of the maintenance information is composed of the management number, the model name, a responsible business office, a next maintenance date, a use status, and a diagnosis result.

In the maintenance information, the management number is a number for identifying the image forming apparatus 10, like the management number in the apparatus management table 53 illustrated in FIG. 5.

In the maintenance information, the model name represents the name of the model of the image forming apparatus 10 represented by the management number, like the model name in the used component table 52 illustrated in FIG. 4 and the model name in the apparatus management table 53 illustrated in FIG. 5.

In the maintenance information, the responsible business office represents the name of a business office responsible for the maintenance of the image forming apparatus 10 represented by the management number. In place of the name of the business office, the IP address of the maintenance terminal 50 installed in the business office may be set as the name of the responsible business office.

In the maintenance information, the next maintenance date represents the next maintenance date scheduled for the image forming apparatus 10 represented by the management number.

In the maintenance information, the use status represents a use status, in the image forming apparatus 10, of the identified component regarding which the anomaly diagnosis request is made. The use status “in use” denotes that the image forming apparatus 10 represented by the management number is using the identified component regarding which the anomaly diagnosis request is made. In contrast, the use status “unused” denotes that the image forming apparatus 10 represented by the management number does not use the identified component regarding which the anomaly diagnosis request is made.

In the maintenance information, the diagnosis result represents the state of the identified component in the image forming apparatus 10 represented by the management number. The diagnosis result “OK” denotes that the identified component does not have a failure. In contrast, the diagnosis result “failure” denotes that the identified component has a failure.

The maintenance planning part 25 sets the use status of the identified component and the diagnosis result in the maintenance management table 54 on the basis of the diagnosis result. Since the image forming apparatus 10 represented by the management number added to the diagnosis result corresponds to the image forming apparatus 10 using the identified component, “in use” is set as the use status. The use status of the identified component may be set in the maintenance management table 54 by the apparatus identification part 23 before the anomaly diagnosis request is transmitted from the communication part 21.

Items included in the maintenance information are not limited to items illustrated in FIG. 7. For example, a maintenance record such as a date when maintenance has been performed or the name of a maintenance person may be included in the maintenance information.

In consideration for the scheduled maintenance date for the image forming apparatus 10 that is represented by, for example, the next maintenance date in the maintenance management table 54, the maintenance planning part 25 decides the image forming apparatus 10 to be assigned the stocked identified component with priority from among the image forming apparatuses 10 determined as including the identified component having a failure. A specific method for assigning the stocked identified component will be described later.

The management server 20 receives operating information from each image forming apparatus 10 at predetermined timing such as once a day or as occasion demands. The operating information is information regarding the use of the image forming apparatus 10 by users. The management controller 24 updates an operating information table 55 stored in an operating information DB 26D every time the management controller 24 receives the operating information regarding the image forming apparatus 10 from the communication part 21.

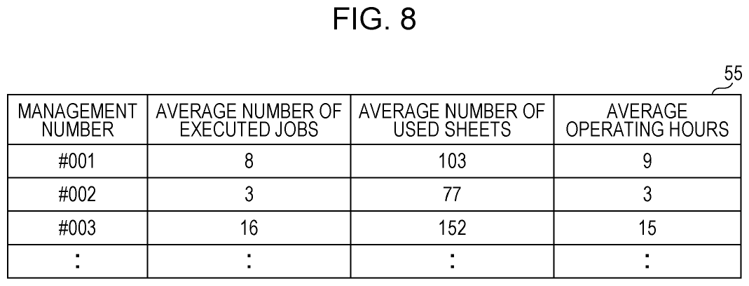

FIG. 8 is a view illustrating an example of the operating information table 55. As illustrated in FIG. 8, the operating information table 55 includes the operating information regarding the image forming apparatus 10. Each of the pieces of the operating information is composed of the management number, the average number of executed jobs, the average number of used sheets, and average operating hours.

In the operating information, the management number is a number for identifying the image forming apparatus 10, like the management number in the apparatus management table 53 illustrated in FIG. 5.

In the operating information, the average number of executed jobs represents the average number of times a job is executed in the image forming apparatus 10 represented by the management number per unit period. The job is a unit for implementing a function in the image forming apparatus 10. The average number of executed jobs is information indicating the use frequency of the image forming apparatus 10, focused on the number of jobs executed in the image forming apparatus 10.

In the operating information, the average number of used sheets represents the average number of paper sheets P used in the image forming apparatus 10 represented by the management number per unit period. The average number of used sheets is information indicating the use frequency of the image forming apparatus 10, focused on the consumable article consumption in the image forming apparatus 10.

In the operating information, the average operating hours represents the average hours when the image forming apparatus 10 represented by the management number operates per unit period. The average operating hours is information indicating the use frequency of the image forming apparatus 10, focused on the operating hours of the image forming apparatus 10.

There is no limitation on the unit period used for the operating information. For example, any period such as a day or a month may be used as the unit period.

Items included in the operating information are not limited to items illustrated in FIG. 8. For example, different information such as average color material consumption per unit period in the image forming apparatus 10 or an average data communication amount per unit period may be used to represent the use frequency of the image forming apparatus 10.

The maintenance planning part 25 may refer to the operating information table 55 and may thereby decide the image forming apparatus 10 to be assigned the stocked identified component with priority from the operating information regarding the image forming apparatus 10 in addition to or in place of the scheduled maintenance date for the image forming apparatus 10. A specific method for assigning the stocked identified component using the operating information table 55 will be described later.

The stock management DB 26A, the apparatus management DB 26B, the maintenance management DB 26C, and the operating information DB 26D do not necessarily have to be provided in the memory 26 of the management server 20. For example, the stock management DB 26A, the apparatus management DB 26B, the maintenance management DB 26C, and the operating information DB 26D may be provided in an external apparatus serving as a data server.

In contrast, FIG. 9 is a view illustrating an example functional configuration of the image forming apparatus 10. The image forming apparatus 10 includes functional parts that are a communication part 11, an image forming part 12, an unusual-sound detection part 13, a failure determination part 14, and an apparatus controller 15, a memory 16, and the microphone 17.

The communication part 11 interactively performs data communication with the management server 20 via the communication network 2. The communication part 11 may interactively perform data communication with a different one of the image forming apparatuses 10. Further, the communication part 11 may interactively perform data communication with an external apparatus connected to the communication network 2.

If a user issues an instruction to execute the printing function, the image forming part 12 forms, on the paper sheet P, an image represented by image data for printing by using the image forming unit 37D and color materials. There is no limitation on an image forming method performed on the image forming part 12, and, for example, any of an inkjet system and an electrophotographic system may be used.

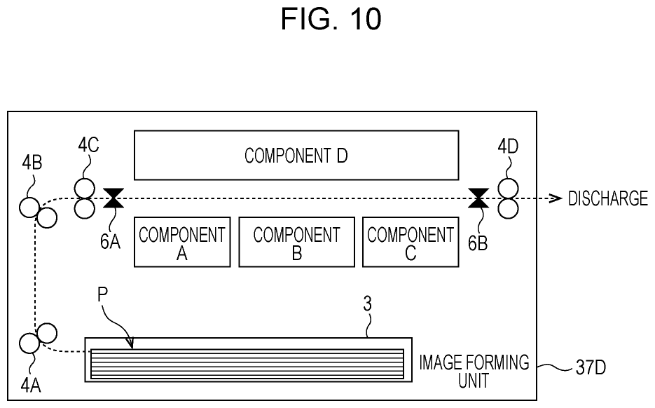

FIG. 10 is an example schematic view of the image forming unit 37D. The image forming unit 37D includes a media supply container 3 containing, for example, the paper sheets P, a component A to a component D used to form an image on the paper sheet P, transport rollers 4A to transport rollers 4D that transport the paper sheet P contained in the media supply container 3 to a discharging exit along a transportation path (the path indicated by the dotted line in FIG. 10), and a detection sensor 6A and a detection sensor 6B that detect the paper sheet P transported along the transportation path.

A schematic view of the image forming unit 37D illustrated in FIG. 10 is a view conceptually explaining the operation of the image forming unit 37D.

The transport rollers 4A to the transport rollers 4D transport the paper sheets P contained in the media supply container 3 one by one along the transportation path. When one of the paper sheets P is transported between the detection sensor 6A and the detection sensor 6B, the image forming unit 37D forms an image represented by image data on the paper sheet P. The detection sensor 6A thus detects a side (referred to as a leading edge of the paper sheet P) that is located downstream in a direction of transporting the paper sheet P and that is orthogonal to the transportation direction. The detection sensor 6B detects a side (referred to as a trailing edge of the paper sheet P) that is located upstream in the direction of transporting the paper sheet P and that is orthogonal to the transportation direction. The detection sensor 6A and the detection sensor 6B thus detects a period from the start to the end of the image forming on the paper sheet P. A period from the start to the end of the image forming on one paper sheet P is referred to as an image forming period 5.

For example, if the unit name corresponding the use of the identified component is the image forming unit 37D, reference sound data to be transmitted to each image forming apparatus 10 using the identified component by the management server 20 together with the anomaly diagnosis request is sound data regarding the image forming unit 37D appropriately operating, the sound data being data regarding sound collected in the image forming period 5 with the microphone 17.

In the schematic view the image forming unit 37D illustrated in FIG. 10, the component A to the component D are discriminated from the transport rollers 4A to the transport rollers 4D, the detection sensor 6A, and the detection sensor 6B in the description for convenience of explanation; however, the transport rollers 4A to the transport rollers 4D, the detection sensor 6A, and the detection sensor 6B are also examples of the components included in the image forming unit 37D. Components not illustrated in FIG. 10 such as a motor that drives the transport rollers 4A to the transport rollers 4D and a belt that transmits the rotation of the motor to the transport rollers 4A to the transport rollers 4D are also examples of the components included in the image forming unit 37D.

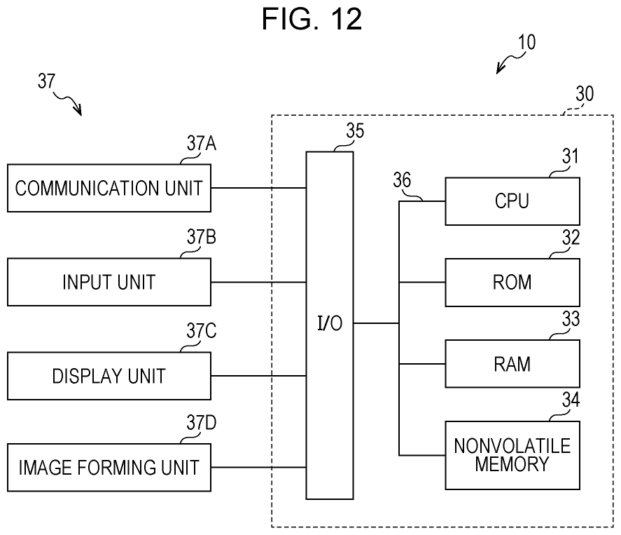

The image forming apparatus 10 includes another unit 37, for example, the input unit 37B that receives a user operation in addition to the image forming unit 37D as to be described later with reference to FIG. 12.

From operating sound of the unit 37 corresponding to the unit name corresponding the use of the identified component that is added to the anomaly diagnosis request and that represents the unit using the identified component, the unusual-sound detection part 13 detects whether the unit 37 has any anomaly.

Specifically, if the unit name corresponding the use of the identified component is the image forming unit 37D, the unusual-sound detection part 13 compares operating sound data representing the operating sound of the image forming unit 37D collected with the microphone 17 while the printing function is implemented with the reference sound data transmitted from the management server 20 and detects whether the image forming unit 37D has any anomaly. The microphone 17 is thus installed in the location enabling the operating sound of each unit 37 to be collected, for example, the inside or around the unit 37.

If an anomaly is detected in the unit 37 using the identified component, the unusual-sound detection part 13 extracts, from the acquired operating sound data, operating sound data regarding a portion corresponding to the operating period of the identified component designated in the anomaly diagnosis request among the components included in the unit 37 and outputs the operating sound data to the apparatus controller 15. The operating sound data regarding the operating identified component that is extracted from the operating sound data regarding the unit 37 using the identified component is referred to as analysis target data.

Processing in the unusual-sound detection part 13 is implemented by operations of a detection controller 13A included in the unusual-sound detection part 13, a sound collection controller 13B, a frequency analysis part 13C, and an unusual-sound determination part 13D.

The sound collection controller 13B controls the microphone 17 in accordance with an instruction from the detection controller 13A and acquires the operating sound data regarding the unit 37 designated in the anomaly diagnosis request.

The frequency analysis part 13C performs frequency analysis of the operating sound data acquired by the sound collection controller 13B and generates frequency analysis data. The frequency analysis data is data indicating chronological changes in frequency component in the operating sound data chronologically and is also referred to as short-time Fourier transform (STFT) data. The frequency component in the operating sound data is acquired by performing STFT on the operating sound data.

The frequency analysis part 13C also generates frequency analysis data (hereinafter, referred to as ground truth data) for the reference sound data regarding the unit 37 using the identified component, the reference sound data being received together with the anomaly diagnosis request from the management server 20. To eliminate the need for the frequency analysis part 13C to generate the ground truth data from the reference sound data, the management server 20 may transmit, to the image forming apparatus 10, the ground truth data as the reference sound data added to the anomaly diagnosis request.

The unusual-sound determination part 13D compares the ground truth data with the frequency analysis data acquired by the frequency analysis part 13C for the operating sound data and thereby determines whether an anomaly occurs in the operation of the unit 37 using the identified component.

If an anomaly is determined as occurring in the operation of the unit 37 using the identified component, the unusual-sound determination part 13D reports the occurrence of the anomaly to the detection controller 13A.

The detection controller 13A controls the sound collection controller 13B, the frequency analysis part 13C, and the unusual-sound determination part 13D and causes the unusual-sound detection part 13 to perform the processing. In addition, in response to receiving the report of anomaly occurrence in the unit 37 from the unusual-sound determination part 13D, the detection controller 13A also outputs the anomaly occurrence report to the apparatus controller 15. If an anomaly occurs in the unit 37 using the identified component, the detection controller 13A also outputs analysis target data regarding the identified component to the apparatus controller 15.

If the apparatus controller 15 receives the anomaly occurrence report from the detection controller 13A, the apparatus controller 15 outputs, to the failure determination part 14, the analysis target data regarding the identified component received from the detection controller 13A.

The failure determination part 14 diagnoses the state of the identified component by using the analysis target data regarding the identified component received from the apparatus controller 15 and outputs the result of the diagnosis to the apparatus controller 15. To diagnose the state of the identified component, a publicly known diagnosis method using operating sound data, such as comparing operating sound data in a state where the identified component is appropriately operating and the analysis target data.

The apparatus controller 15 controls the communication part 11 and thereby transmits, to the management server 20, the diagnosis result received from the failure determination part 14 together with the management number of the image forming apparatus 10.

As described above, the apparatus controller 15 controls the functional parts that are the communication part 11, the image forming part 12, the unusual-sound detection part 13, and the failure determination part 14 and thereby performs control to diagnose the state of the identified component from the operating sound of the unit 37 using the identified component.

The memory 16 includes an operating sound DB 16A, a determination DB 16B, and a record DB 16C, and the unusual-sound detection part 13 stores and acquires various pieces of data.

The sound collection controller 13B stores the operating sound data regarding the unit 37 using the identified component in the operating sound DB 16A.

In the determination DB 16B, data such as the frequency analysis data used to detect an unusual sound of the unit 37 using the identified component is stored.

In the record DB 16C, operation logs of the image forming apparatus 10 is stored. Each operation log is generated by the apparatus controller 15. The detection controller 13A receives the operation log from the apparatus controller 15 and stores the operation log in the record DB 16C. The operation logs of the image forming apparatus 10 are examples of operation records in which the operating states of the components included in the image forming apparatus 10 are recorded. The operation logs are stored, for example, for each unit 37 of the image forming apparatus 10.

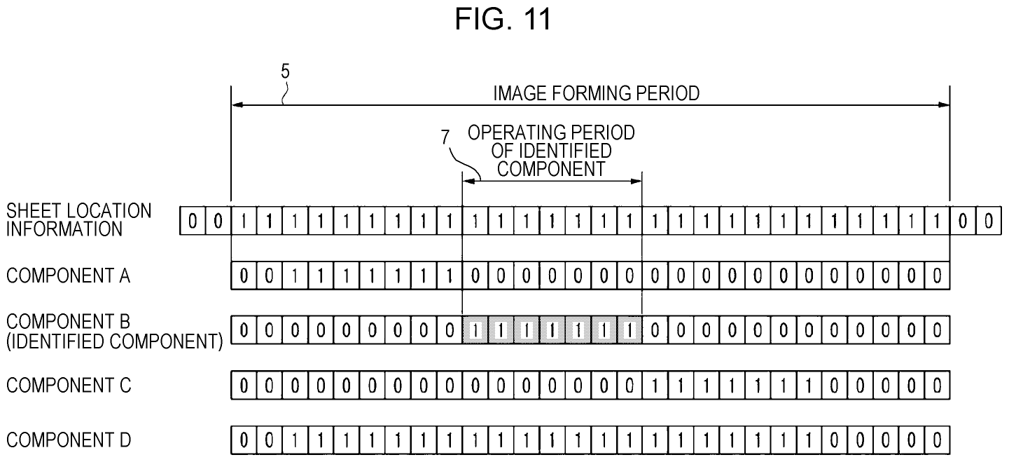

FIG. 11 is a view illustrating example operation logs. The operation logs illustrated in FIG. 11 are examples of the operation logs of the image forming unit 37D illustrated in FIG. 10, and each operation log is described chronologically from the left to the right in FIG. 11.

The sheet location information is an operation log representing whether at least one of the leading edge or the trailing edge of a paper sheet P is present within the transportation path from the detection sensor 6A to the detection sensor 6B. If at least one of the leading edge or the trailing edge of the paper sheet P is present within the transportation path from the detection sensor 6A to the detection sensor 6B, for example, “1” is set in the sheet location information. If not, for example, “0” is set in the sheet location information. A period in which “1” is set in the sheet location information thus represents the image forming period 5.

In the respective operation logs of the component A to the component D, “0” denotes a state where the component is not operating, and “1” denotes a state where the component is operating. For example, a period for which “1” is set in the operation log of the component B thus represents the operating period of the component B.

The detection controller 13A thus identifies the operating period of an identified component with reference to the operation log of the unit 37 using the identified component. For example, if the component B is the identified component, a period 7 in FIG. 11 is the operating period of the identified component. The detection controller 13A extracts operating sound data regarding a portion corresponding to the operating period of the identified component from the operating sound data regarding the unit 37 using the identified component and thereby generates analysis target data regarding the identified component.

As described above, with reference to various pieces of data stored in the operating sound DB 16A, the determination DB 16B, and the record DB 16C, the unusual-sound detection part 13 and the failure determination part 14 respectively detect an unusual sound during the operation of the unit 37 using the identified component and diagnoses the state of the identified component.

The image forming apparatus 10 and the management server 20 that perform the processing as described above may be respectively configured by using a computer 30 and a computer 40. FIG. 12 is a view illustrating an example configuration of an electrical system of the image forming apparatus 10 including the computer 30.

The computer 30 includes a central processing unit (CPU) 31, a read only memory (ROM) 32, a random access memory (RAM) 33, a nonvolatile memory 34, and an input/output interface (I/O) 35. The CPU 31 is an example of a second processor that performs processing of each functional part of the image forming apparatus 10 illustrated in

FIG. 9. The ROM 32 stores a startup program (basic input output system (BIOS)) that executes a process for starting the computer 30. The RAM 33 is used as a temporary work area for the CPU 31. The CPU 31, the ROM 32, the RAM 33, the nonvolatile memory 34, and the I/O 35 are connected to each other via a bus 36.

The nonvolatile memory 34 is an example of the memory 16 in which stored information is maintained even if power supplied to the nonvolatile memory 34 is disconnected. For example, a semiconductor memory is used therefor, but a hard disk may be used. The nonvolatile memory 34 stores a processing program that specifies operations of the image forming apparatus 10. The CPU 31 loads the processing program from the nonvolatile memory 34 and runs the processing program, and thereby the image forming apparatus 10 operates.

To the I/O 35, the unit 37 in a structure for implementing, for example, the functions of the image forming apparatus 10. In the example illustrated in FIG. 12, a communication unit 37A, the input unit 37B, a display unit 37C, and the image forming unit 37D are connected to the I/O 35.

The communication unit 37A is connected to the communication network 2 and is an example of the unit 37 that performs data communication with apparatuses connected to the communication network 2 in accordance with a predetermined communication protocol.

The input unit 37B is an example of the unit 37 that receives an operation by the user and reports the operation to the CPU 31, and, for example, buttons, a touch panel, or the like is used as the input unit 37B

The display unit 37C is an example of the unit 37 that visually displays information processed by the CPU 31, and, for example, a liquid crystal display, an organic electro luminescence (EL) display, or the like is used as the display unit 37C.

The image forming unit 37D is an example of the unit 37 that forms an image on the paper sheet P by using the color materials, as has been described by using FIG. 10.

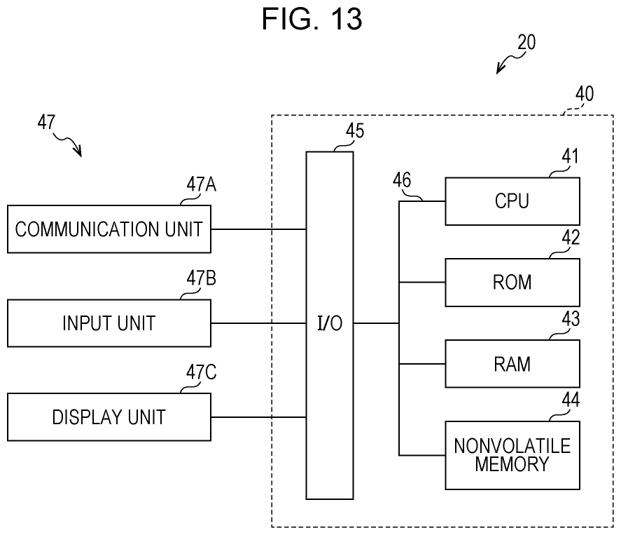

In contrast, FIG. 13 is a view illustrating an example configuration of an electrical system of the management server 20 including the computer 40.

The computer 40 includes a CPU 41, a ROM 42, a RAM 43, a nonvolatile memory 44, and an I/O 45. The CPU 41 is an example of a first processor that performs the processing in the management server 20. The ROM 42 stores a BIOS that executes a process for starting the computer 40. The RAM 43 is used as a temporary work area for the CPU 41. The CPU 41, the ROM 42, the RAM 43, the nonvolatile memory 44, and the I/O 45 are connected to each other via a bus 46. The nonvolatile memory 44 is an example of the memory 26 including the stock management DB 26A, the apparatus management DB 26B, the maintenance management DB 26C, and the operating information DB 26D.

To the I/O 45, a unit 47 in a structure for implementing, for example, the functions of the management server 20. In the example illustrated in FIG. 13, a communication unit 47A, an input unit 47B, and a display unit 47C are connected to the I/O 45.

The communication unit 47A is connected to the communication network 2 and is an example of the unit 47 that performs data communication with apparatuses connected to the communication network 2 in accordance with a predetermined communication protocol.

The input unit 47B is an example of the unit 47 that receives an operation by a system administrator that manages the management server 20 and reports the operation to the operation CPU 41, and, for example, a keyboard, a mouse, or the like is used as the input unit 47B.

The display unit 47C is an example of the unit 47 that visually displays information processed by the CPU 41, and, for example, a liquid crystal display, an EL display, or the like is used as the display unit 47C, like the display unit 37C of the image forming apparatus 10.

Actions of the functions implemented by the management server 20 will then be described.

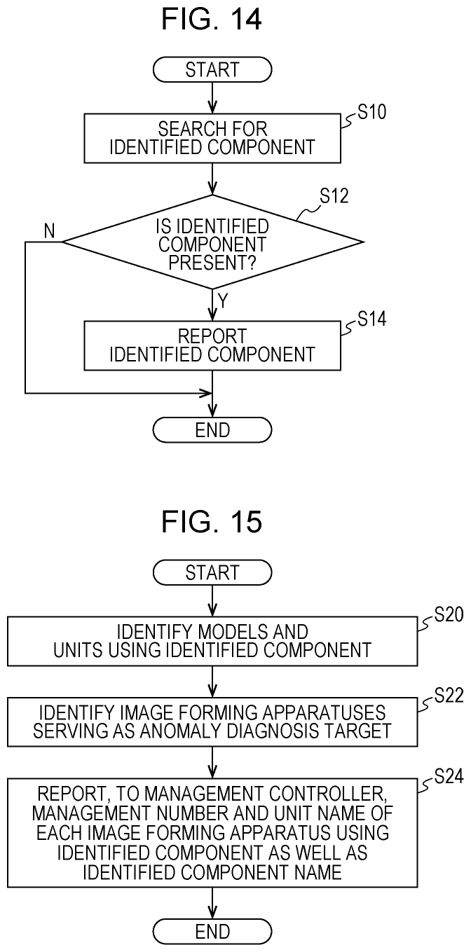

FIG. 14 is a flowchart illustrating an example of the determination process for determining whether an identified component is present. The determination process is executed by the stock management part 22 of the management server 20 at timing designated by the system administrator, for example, at predetermined timing such as every day.

A management program that specifies the determination process is stored in advance, for example, in the nonvolatile memory 44 of the management server 20. The CPU 41 of the management server 20 loads the management program stored in the nonvolatile memory 44 and executes the determination process.

In step S10, the stock management part 22 refers to the stock table 51 and thereby searches the stock table 51 for any component the quantity of stock of which is lower than or equal to the stock threshold in the components used for the image forming apparatuses 10, that is, an identified component.

In step S12, the stock management part 22 determines whether an identified component is present as the result of the searching in step S10. If an identified component is present, the process moves to step S14.

In step S14, the stock management part 22 reports the component name of the identified component to the apparatus identification part 23, and the determination process in

FIG. 14 is terminated.

In contrast, if it is determined that an identified component is not present in step S12, the determination process in FIG. 14 is terminated without performing step S14. This is because it is considered that a situation of stockout of a component required for maintenance is not likely to arise even if any anomaly occurs in the image forming apparatus 10.

In the example of the stock table 51 illustrated in FIG. 3, the total stock of the component B in the warehouse A, the warehouse B, and the warehouse C is 15. In contrast, a stock threshold for the component B is 20. The component B is thus retrieved as an identified component and is reported as the identified component to the apparatus identification part 23.

The stock threshold may be regularly updated by the stock management part 22 on the basis of the length of a delivery period for the component and a past repair status of the image forming apparatus 10. For example, the stock management part 22 sets a higher stock threshold for a component having a longer period for delivery and a higher replacement frequency.

FIG. 15 is a flowchart illustrating an example of an identification process for identifying the image forming apparatuses 10 using the identified component. The identification process is executed by the apparatus identification part 23 of the management server 20 in response to receiving the report regarding an identified component from the stock management part 22. The CPU 41 of the management server 20 loads the management program stored in the nonvolatile memory 44 and thereby executes the identification process.

In step S20, the apparatus identification part 23 refers to the used component table 52 and thereby identifies the models of the image forming apparatuses 10 using the identified component and the units 37 using the identified component corresponding to the models.

In step S22, the apparatus identification part 23 refers to the apparatus management table 53 and thereby identifies the image forming apparatuses 10 serving as an anomaly diagnosis target by acquiring management numbers of all the image forming apparatuses 10 of the relevant models using the identified component.

In step S24, the apparatus identification part 23 reports, to the management controller 24, each management number of the corresponding image forming apparatus 10 using the identified component that is acquired in step S22, each unit name of the corresponding unit 37 using the identified component that is identified in step S20, and the component name of the identified component in association with each other for each management number of the image forming apparatus 10 using the identified component. The identification process illustrated in FIG. 15 is then terminated.

In the identification process, not only all the image forming apparatuses 10 using the identified component but also each unit 37 using the identified component in the image forming apparatus 10 is identified.

For example, assume that the component B is the identified component in the used component table 52 and the apparatus management table 53 respectively illustrated in FIGS. 4 and 5. The used component table 52 proves that the identified component is used for, for example, the image forming unit 37D of a model A. Further, the apparatus management table 53 proves that the management numbers of the image forming apparatuses 10 of the model A are “#001” in a place A and “#002” in a place C.

The management controller 24 having received the management number of each image forming apparatus 10 using the identified component, the unit name thereof, and the component name of the identified component acquires the reference sound data regarding the unit 37 using the identified component from the maintenance management DB 26C. The management controller 24 then controls the communication unit 37A and thereby transmits, to the image forming apparatus 10 represented by the reported management number, an anomaly diagnosis request to which the component name of the identified component, the unit name corresponding the use of the identified component, and the reference sound data regarding the unit 37 using the identified component are added.

Each the image forming apparatus 10 to which the anomaly diagnosis request is transmitted thereby transmits the result of diagnosing the identified component to the management server 20.

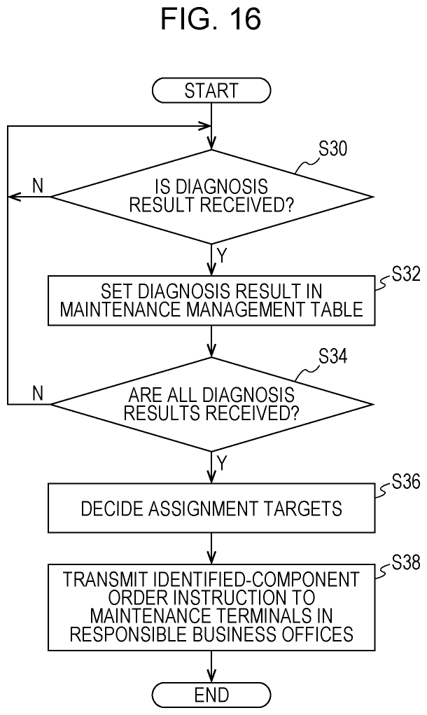

FIG. 16 is a flowchart illustrating an example of a process for assigning the identified component executed by the maintenance planning part 25 of the management server 20 after the anomaly diagnosis request is transmitted to the image forming apparatus 10. The CPU 41 of the management server 20 loads the management program stored in the nonvolatile memory 44 and executes the assignment process.

In step S30, the maintenance planning part 25 determines whether the diagnosis result is received. If the diagnosis result is not received, the determination in step S30 is repeated, and the arrival of the diagnosis result is monitored. In contrast, if the diagnosis result is received, the process moves to step S32.

Since the image forming apparatus 10 having transmitted the diagnosis result uses the identified component, the maintenance planning part 25 sets, in step S32, “in use” in the use status in the maintenance information (referred to as applicable maintenance information) including the management number of the image forming apparatus 10 that has transmitted the diagnosis result to the maintenance management table 54. Further, the maintenance planning part 25 sets the received diagnosis result in the applicable maintenance information.

In step S34, the maintenance planning part 25 determines whether the diagnosis result is received from all of the image forming apparatuses 10 to which the anomaly diagnosis request is transmitted. If the diagnosis result is not received from all of the image forming apparatuses 10 to which the anomaly diagnosis request is transmitted, the maintenance planning part 25 moves to step S30 to receive the diagnosis result. If there is any image forming apparatus 10 that does not transmit the diagnosis result even though a predetermined time period has elapsed since the transmission of the anomaly diagnosis request, the maintenance planning part 25 may prompt the image forming apparatus 10 to transmit the diagnosis result.

In contrast, if the diagnosis result is received from all of the image forming apparatuses 10 to which the anomaly diagnosis request is transmitted, the process moves to step S36. In step S36, the maintenance planning part 25 decides the image forming apparatuses 10 to be assigned the stocked identified component. There are various methods for deciding an image forming apparatus 10 to be assigned the stocked identified component. For example, with reference to the next maintenance date in the maintenance management table 54, the maintenance planning part 25 assigns the stocked identified component in order from one of the image forming apparatuses 10 that is scheduled for the nearest preceding scheduled maintenance date, the image forming apparatuses 10 being determined, from the diagnosis result, as including the identified component having the failure. Assigning the stocked identified component causes the identified component for repair stored in the storage place to be ensured for the image forming apparatus 10. As described above, assigning the stocked identified component causes the required component to be ensured for the date of the maintenance of the image forming apparatus 10.

In step S38, the maintenance planning part 25 reports an order instruction to the management controller 24. The order instruction is reported to instruct the maintenance terminal 50 of the responsible business office responsible for the maintenance of the image forming apparatus 10 assigned the stocked identified component to place an order for the component with the storage place of the identified component. The management controller 24 having received the order instruction controls the communication unit 37A and thereby transmits the order instruction to the maintenance terminal 50 designated by the maintenance planning part 25. The assignment process illustrated in FIG. 16 is then terminated.

For example, as illustrated in the maintenance management table 54 in FIG. 7, the image forming apparatuses 10 using the identified component are only the two image forming apparatuses 10 represented by the management numbers “#001” and “#002”. In this case, the diagnosis result of the image forming apparatus 10 represented by the management number “#001” is “failure”, and the diagnosis result of the image forming apparatus 10 represented by the management number “#002” is “OK”. The maintenance planning part 25 thus assigns the identified component to the image forming apparatus 10 represented by the management number “#002” without the need for the consideration for the next maintenance date.

If the diagnosis result of the image forming apparatus 10 represented by the management number “#002” is also “failure”, the next maintenance date of the image forming apparatus 10 represented by the management number “#001” is nearer than the next maintenance date of the image forming apparatus 10 represented by the management number “#002” is. The maintenance planning part 25 thus ranks, first, the precedence in assigning the identified component to the image forming apparatus 10 represented by the management number “#001” and, second, the precedence in assigning the identified component to the image forming apparatus 10 represented by the management number “#002”. If the number of identified components required to be replaced exceeds the quantity of stock, the maintenance planning part 25 sets the precedence in assigning the identified component to the image forming apparatuses 10 to prevent the number of identified components from exceeding the quantity of stock. The maintenance planning part 25 reports the order instruction based on precedence in assigning the identified component to the management controller 24.

In contrast, a maintenance person belonging to the responsible business office places an order for the identified component with the storage place of the component in accordance with the order instruction received with the maintenance terminal 50.

The transmission of the order instruction to the maintenance terminal 50 is an example for outputting the instruction to assign a stocked identified component to each image forming apparatus 10. The management server 20 may disclose the result of the identified component assignment on the homepage to enable the maintenance terminal 50 to view the result. The management server 20 may display the result of the identified component assignment on the display unit 47C of the management server 20 and may also store the result in the nonvolatile memory 44. Further, the management server 20 may transmit, to the image forming apparatus 10 assigned the identified component, assignment information indicating that the identified component has been assigned to cause the display unit 37C of the image forming apparatus 10 to display the identified component assignment to the image forming apparatus 10. The forms as described above are also an example for outputting the instruction to assign a stocked identified component to the image forming apparatus 10.

### Modification 1

In the description above, in consideration for the scheduled maintenance date for the image forming apparatus 10, the management server 20 decides the image forming apparatuses 10 to be assigned the stocked identified component with priority from among the image forming apparatuses 10 determined as including the identified component having a failure. However, the method for assigning a stocked identified component to the image forming apparatus 10 is not necessarily influenced by the scheduled maintenance date only.

The management server 20 may set precedence in assigning the stocked identified component to each image forming apparatus 10 in consideration for at least one of the scheduled maintenance date for the image forming apparatus 10, a distance from the warehouse where the identified component is stored to the installation place where the image forming apparatus 10 is installed, or the use frequency of the image forming apparatus 10.

For example, even if orders for the identified component are placed with warehouses at the same time, the identified component may be delivered earlier to the image forming apparatus 10 located at a shorter distance from the corresponding warehouse. The management server 20 may thus assign the stocked identified component in order, among the image forming apparatuses 10 determined as including the identified component having a failure, to the image forming apparatus 10 located at the shortest distance from the warehouse closest to the image forming apparatus 10 to the installation place where the image forming apparatus 10 is installed.

In addition, the more frequently users use an image forming apparatus 10, the more highly the unavailability of the image forming apparatus 10 influences the users. The stocked identified component is thus preferably assigned, with priority, to the image forming apparatus 10 more frequently used by the users.

The use frequency of the image forming apparatus 10 is recorded as the operating information in the operating information table 55. The management server 20 may thus refer to the operating information table 55 illustrated in FIG. 8 and may thereby assign the stocked identified component in order, among the image forming apparatuses 10 determined as including the identified component having a failure, from the image forming apparatus 10 in which the largest number of jobs are executed on average, the image forming apparatus 10 in which the largest number of sheets are used on average, or the image forming apparatus 10 that operates for the longest hours on average.

It goes without saying that the management server 20 may evaluate the use frequency of the image forming apparatus 10 in such a manner as to combine at least two items of the average number of executed jobs, the average number of used sheets, and the average operating hours.

Suppose a case where when the management server 20 decides the precedence in assigning the stocked identified component on the basis of the nearness of the preceding scheduled maintenance date, there are multiple image forming apparatuses 10 determined as including the identified component having a failure have the same next maintenance date. In this case, the management server 20 may assign the stocked identified component with priority to an image forming apparatus 10 used more frequently by the users among the image forming apparatuses 10 having the same next maintenance date. Assigning the stocked identified component with priority to an image forming apparatus 10 used more frequently by the users denotes that the use frequency of each image forming apparatus 10 is evaluated by using at least one of the average number of executed jobs, the average number of used sheets, or the average operating hours and that the stocked identified component is assigned in order from the image forming apparatus 10 most frequently used by the users, as described above.

As has been described above, the use frequency of the image forming apparatus 10 is also represented by using an item other than the average number of executed jobs, the average number of used sheets, and the average operating hours, such as average color material consumption per unit period or an average data communication amount per unit period. Accordingly, if information indicating the use frequency of the image forming apparatus 10 other than the average number of executed jobs, the average number of used sheets, and the average operating hours is also recorded in the operating information table 55, the management server 20 may evaluate the use frequency of the image forming apparatus 10 by using such information indicating the use frequency of the image forming apparatus 10.

In contrast, suppose a case where when the management server 20 decides the precedence in assigning the stocked identified component on the basis of the frequency of use by the users, there are multiple image forming apparatuses 10 determined as including the identified component having a failure have the same frequency of use by the users. In this case, the management server 20 may assign the stocked identified component with priority to an image forming apparatus 10 having a nearer preceding scheduled maintenance date among the image forming apparatuses 10 having the same use frequency.

### Modification 2

As illustrated in FIG. 11, the operating period for each component is recorded in the operation log of the image forming apparatus 10. Accordingly, each image forming apparatus 10 refers to the operation log and may thereby identify, by itself, the operating period of the identified component designated as a diagnosis target.

However, in some models of the image forming apparatuses 10, an operating period per component is not recorded in the operation log. In this case, it is not possible to extract operating sound data regarding the portion corresponding to the operating period of the identified component from the operating sound data regarding the unit 37 using the identified component. Accordingly, each image forming apparatus 10 of such models has to diagnose the state of the identified component by using the entire operating sound data regarding the unit 37 in which the operating period of the identified component is unknown. The state of the identified component is diagnosed more accurately by using operating sound data regarding the identified component in the operating period than by using operating sound data in which the location of the operating sound of the identified component is unknown.

Accordingly, when transmitting the anomaly diagnosis request to the image forming apparatus 10 of the model without the operating period per component recorded in the operation log, the management server 20 also adds the operating period information indicating the operating period of the identified component to the anomaly diagnosis request. The operating period information is information indicating a period in which the identified component is operating in a period from the start to the end of the operation of the unit 37 using the identified component.

As described above, when transmitting the anomaly diagnosis request to the image forming apparatus 10 without the operating period per component recorded in the operation log, the management server 20 transmits the operating period information regarding the identified component together. Even in the image forming apparatus 10 without the operating period per component recorded in the operation log, the identified component is diagnosed by using the operating sound data regarding the identified component in the operating period.

The example in which the management server 20 transmits the anomaly diagnosis request with the reference sound data regarding the unit 37 using the identified component to each image forming apparatus 10 serving as the anomaly diagnosis target has heretofore been described. However, if the reference sound data per unit 37 is stored in advance in the nonvolatile memory 34 of the image forming apparatus 10, the management server 20 does not have to add the reference sound data regarding the unit 37 using the identified component to the anomaly diagnosis request. In this case, the image forming apparatus 10 having received the anomaly diagnosis request acquires the reference sound data corresponding to the unit name added to the anomaly diagnosis request from the nonvolatile memory 34 and determines whether an anomaly occurs in the operation of the unit 37 in such a manner as to compare the operating sound data regarding the unit 37 corresponding to the unit name added to the anomaly diagnosis request with the reference sound data.

An aspect of the management system 1 has heretofore been described by using the exemplary embodiment. The form as the disclosed management system 1 is an example and is not limited to the scope of the exemplary embodiment described. Various modifications and improvements may be made to the exemplary embodiment without departing from the spirit of the disclosure, and an exemplary embodiment to which the modification or the improvement is made may also be included in the technical scope of the disclosure.

For example, the order of steps in the processes illustrated in FIGS. 14 to 16 may be changed without departing from the spirit of the disclosure.

In the exemplary embodiment above, the case where the processes illustrated in FIGS. 14 to 16 are implemented by software has been described as an example. However, processes equivalent to the flowcharts of the processes above may be executed by hardware. In this case, each process is executed more quickly than in the case where the process is executed by the software.

In the embodiments above, the term “processor” refers to hardware in a broad sense. Examples of the processor include general processors (e.g., the CPUs 31 and 41) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiment above, the example in which the management program is stored in the nonvolatile memory 44 has heretofore been described. However, the storage place of the management program is not limited to the nonvolatile memory 44. The management program of the disclosure may be provided in such a manner as to be recorded in the storage medium readable by the computer 40.

For example, the management program may be provided in such a manner as to be recorded in an optical disk such as a compact disk (CD)-ROM or a digital versatile disc (DVD)-ROM. The management program may also be provided in such a manner as to be recorded in a portable semiconductor memory such as a universal serial bus (USB) memory or a flash memory. The ROM 42, the nonvolatile memory 44, CD-ROM, DVD-ROM, USB, and the memory card are each an example of a non-transitory storage medium.

Likewise, the processing program of the image forming apparatus 10 may be provided in such a manner as to be recorded in the storage medium readable by the computer 30.

Further, the management server 20 may download the management program from an external apparatus connected to the communication network 2 via the communication unit 47A and store the downloaded management program in the nonvolatile memory 44. In this case, the CPU 41 of the management server 20 loads the management program downloaded from the external apparatus from the nonvolatile memory 44 and then executes the various processes.

Likewise, the image forming apparatus 10 may download the processing program from an external apparatus connected to the communication network 2 via the communication unit 37A and may store the downloaded processing program in the nonvolatile memory 34.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A management apparatus includes a processor configured to:
detect an identified component quantity of stock of which is lower than or equal to a threshold from among components included in each of processing apparatuses that are connected by using a communication network;
transmit, to a processing apparatus of the processing apparatuses that uses the identified component, an anomaly diagnosis request for diagnosing whether the identified component has a failure;
receive a result of diagnosing the identified component from the processing apparatus to which the anomaly diagnosis request is transmitted; and
output an instruction to assign a stocked identified component to a processing apparatus of the processing apparatuses that is determined as including the identified component having the failure on a basis of the result of diagnosing the identified component.
   (((2)))

In the management apparatus according to (((1))),
the processor is configured to: add reference sound data to the anomaly diagnosis request and transmit the anomaly diagnosis request to the processing apparatus that uses the identified component, the reference sound data being data in which sound acquired in a state where each of the components included in the processing apparatus does not have the failure is recorded.
   (((3)))

In the management apparatus according to (((1))),
the processor is configured to: add reference sound data to the anomaly diagnosis request and transmit the anomaly diagnosis request to the processing apparatus that uses the identified component, the reference sound data being extracted from sound acquired in a state where each of the components included in the processing apparatus does not have the failure.
   (((4)))

In the management apparatus according to any one of (((1))) to (((3))),
the processor is configured to: add operating period information indicating an operating period of the identified component to the anomaly diagnosis request and transmit the anomaly diagnosis request to the processing apparatus that uses the identified component.
   (((5)))

In the management apparatus according to any one of (((1))) to (((4))),
the processor is configured to: set precedence in assigning the stocked identified component to the processing apparatus determined as including the identified component having the failure from the result of diagnosing the identified component, the precedence being set in consideration for at least one of a scheduled maintenance date for the processing apparatus, a distance from a warehouse where the identified component is stored to an installation place where the processing apparatus is installed, or a use frequency of the processing apparatus.
   (((6)))

In the management apparatus according to (((5))), the processor is configured to: assign the stocked identified component in order from one of the processing apparatuses that is scheduled for a nearest preceding scheduled maintenance date.

(((7)))

In the management apparatus according to (((6))),
in response to the multiple processing apparatuses scheduled for identical scheduled maintenance dates, the stocked identified component is assigned in order from one of the processing apparatuses that operates for longest operating hours or has highest consumption of a consumable article in a unit period.
   (((8)))

In the management apparatus according to any one of (((5))) to (((7))),
the processor is configured to: assign the stocked identified component in order from one of the processing apparatuses that is located at the distance that is shortest.
   (((9)))

In the management apparatus according to any one of (((5))) to (((8))),
the processor is configured to: assign the stocked identified component in order from one of the processing apparatuses that has, in a unit period, longest average operating hours, a largest average number of executed jobs, or highest average consumption of a consumable article.
   (((10)))

A management program causes a computer to execute a process for management, the process including:
detecting an identified component quantity of stock of which is lower than or equal to a threshold from among components included in each of processing apparatuses that are connected by using a communication network;
transmitting, to a processing apparatus of the processing apparatuses that uses the identified component, an anomaly diagnosis request for diagnosing whether the identified component has a failure;
receiving a result of diagnosing the identified component from the processing apparatus to which the anomaly diagnosis request is transmitted; and
outputting an instruction to assign a stocked identified component to a processing apparatus of the processing apparatuses that is determined as including the identified component having the failure on a basis of the result of diagnosing the identified component.
   (((11)))

A management system includes:
multiple processing apparatuses that each implement a function designated by a user; and
a management apparatus that manages an operating state of each of the processing apparatuses.

The management apparatus includes a first processor configured to detect an identified component quantity of stock of which is lower than or equal to a threshold from among components included in each of processing apparatuses that are connected by using a communication network, transmit, to a processing apparatus of the processing apparatuses that uses the identified component, an anomaly diagnosis request for diagnosing whether the identified component has a failure, receive a result of diagnosing the identified component from the processing apparatus to which the anomaly diagnosis request is transmitted, and output an instruction to assign a stocked identified component to a processing apparatus of the processing apparatuses that is determined as including the identified component having the failure on a basis of the result of diagnosing the identified component.

Each of the processing apparatuses includes a second processor configured to acquire operating sound data regarding the processing apparatus in an operating period of the identified component and generate a diagnosis result representing whether the identified component has a failure by using the operating sound data.

What is claimed is:

1. A management apparatus comprising:
a processor configured to:
detect an identified component quantity of stock of which is lower than or equal to a threshold from among components included in each of processing apparatuses that are connected by using a communication network;
transmit, to a processing apparatus of the processing apparatuses that uses the identified component, an anomaly diagnosis request for diagnosing whether the identified component has a failure;
receive a result of diagnosing the identified component from the processing apparatus to which the anomaly diagnosis request is transmitted; and
output an instruction to assign a stocked identified component to a processing apparatus of the processing apparatuses that is determined as including the identified component having the failure on a basis of the result of diagnosing the identified component.

2. The management apparatus according to claim 1,
wherein the processor is configured to:
add reference sound data to the anomaly diagnosis request and transmit the anomaly diagnosis request to the processing apparatus that uses the identified component, the reference sound data being data in which sound acquired in a state where each of the components included in the processing apparatus does not have the failure is recorded.

3. The management apparatus according to claim 1,
wherein the processor is configured to:
add reference sound data to the anomaly diagnosis request and transmit the anomaly diagnosis request to the processing apparatus that uses the identified component, the reference sound data being extracted from sound acquired in a state where each of the components included in the processing apparatus does not have the failure.

4. The management apparatus according to claim 1,
wherein the processor is configured to:
add operating period information indicating an operating period of the identified component to the anomaly diagnosis request and transmit the anomaly diagnosis request to the processing apparatus that uses the identified component.

5. The management apparatus according to claim 1,
wherein the processor is configured to:
set precedence in assigning the stocked identified component to the processing apparatus determined as including the identified component having the failure from the result of diagnosing the identified component, the precedence being set in consideration for at least one of a scheduled maintenance date for the processing apparatus, a distance from a warehouse where the identified component is stored to an installation place where the processing apparatus is installed, or a use frequency of the processing apparatus.

6. The management apparatus according to claim 2,
wherein the processor is configured to:
set precedence in assigning the stocked identified component to the processing apparatus determined as including the identified component having the failure from the result of diagnosing the identified component, the precedence being set in consideration for at least one of a scheduled maintenance date for the processing apparatus, a distance from a warehouse where the identified component is stored to an installation place where the processing apparatus is installed, or a use frequency of the processing apparatus.

7. The management apparatus according to claim 3,
wherein the processor is configured to:
set precedence in assigning the stocked identified component to the processing apparatus determined as including the identified component having the failure from the result of diagnosing the identified component, the precedence being set in consideration for at least one of a scheduled maintenance date for the processing apparatus, a distance from a warehouse where the identified component is stored to an installation place where the processing apparatus is installed, or a use frequency of the processing apparatus.

8. The management apparatus according to claim 4,
wherein the processor is configured to:
set precedence in assigning the stocked identified component to the processing apparatus determined as including the identified component having the failure from the result of diagnosing the identified component, the precedence being set in consideration for at least one of a scheduled maintenance date for the processing apparatus, a distance from a warehouse where the identified component is stored to an installation place where the processing apparatus is installed, or a use frequency of the processing apparatus.

9. The management apparatus according to claim 5,
wherein the processor is configured to:
assign the stocked identified component in order from one of the processing apparatuses that is scheduled for a nearest preceding scheduled maintenance date.

10. The management apparatus according to claim 6,
wherein the processor is configured to:
assign the stocked identified component in order from one of the processing apparatuses that is scheduled for a nearest preceding scheduled maintenance date.

11. The management apparatus according to claim 7,
wherein the processor is configured to:
assign the stocked identified component in order from one of the processing apparatuses that is scheduled for a nearest preceding scheduled maintenance date.

12. The management apparatus according to claim 8,
wherein the processor is configured to:
assign the stocked identified component in order from one of the processing apparatuses that is scheduled for a nearest preceding scheduled maintenance date.

13. The management apparatus according to claim 9,
wherein in response to a plurality of the processing apparatuses scheduled for identical scheduled maintenance dates, the stocked identified component is assigned in order from one of the processing apparatuses that operates for longest operating hours or has highest consumption of a consumable article in a unit period.

14. The management apparatus according to claim 10,
wherein in response to a plurality of the processing apparatuses scheduled for identical scheduled maintenance dates, the stocked identified component is assigned in order from one of the processing apparatuses that operates for longest operating hours or has highest consumption of a consumable article in a unit period.

15. The management apparatus according to claim 11,
wherein in response to a plurality of the processing apparatuses scheduled for identical scheduled maintenance dates, the stocked identified component is assigned in order from one of the processing apparatuses that operates for longest operating hours or has highest consumption of a consumable article in a unit period.

16. The management apparatus according to claim 12,
wherein in response to a plurality of the processing apparatuses scheduled for identical scheduled maintenance dates, the stocked identified component is assigned in order from one of the processing apparatuses that operates for longest operating hours or has highest consumption of a consumable article in a unit period.

17. The management apparatus according to claim 5,
wherein the processor is configured to:
assign the stocked identified component in order from one of the processing apparatuses that is located at the distance that is shortest.

18. The management apparatus according to claim 5,
wherein the processor is configured to:
assign the stocked identified component in order from one of the processing apparatuses that has, in a unit period, longest average operating hours, a largest average number of executed jobs, or highest average consumption of a consumable article.

19. A non-transitory computer readable medium storing a program causing a computer to execute a process for management, the process comprising:
detecting an identified component quantity of stock of which is lower than or equal to a threshold from among components included in each of processing apparatuses that are connected by using a communication network;
transmitting, to a processing apparatus of the processing apparatuses that uses the identified component, an anomaly diagnosis request for diagnosing whether the identified component has a failure;
receiving a result of diagnosing the identified component from the processing apparatus to which the anomaly diagnosis request is transmitted; and
outputting an instruction to assign a stocked identified component to a processing apparatus of the processing apparatuses that is determined as including the identified component having the failure on a basis of the result of diagnosing the identified component.

20. A management system comprising:
a plurality of processing apparatuses that each implement a function designated by a user; and
a management apparatus that manages an operating state of each of the processing apparatuses,
wherein the management apparatus includes a first processor configured to detect an identified component quantity of stock of which is lower than or equal to a threshold from among components included in each of processing apparatuses that are connected by using a communication network, transmit, to a processing apparatus of the processing apparatuses that uses the identified component, an anomaly diagnosis request for diagnosing whether the identified component has a failure, receive a result of diagnosing the identified component from the processing apparatus to which the anomaly diagnosis request is transmitted, and output an instruction to assign a stocked identified component to a processing apparatus of the processing apparatuses that is determined as including the identified component having the failure on a basis of the result of diagnosing the identified component, and
wherein each of the processing apparatuses includes a second processor configured to acquire operating sound data regarding the processing apparatus in an operating period of the identified component and generate a diagnosis result representing whether the identified component has a failure by using the operating sound data.
